(19) United States
(12) Patent Application Publication
(10) Pub. No.: US 2019/0378062 A1
(43) Pub. Date: Dec. 12, 2019

(54) SIMULATION OF INFORMATION SEARCHING ACTION CHANGED WITH AN ANCHOR EVENT

(71) Applicant: FUJITSU LIMITED, Kawasaki-shi (JP)

(72) Inventors: Hiroaki Yamada, Kawasaki (JP); Kotaro Ohori, Sumida (JP)

(73) Assignee: FUJITSU LIMITED, Kawasaki-shi (JP)

(21) Appl. No.: 16/433,040

(22) Filed: Jun. 6, 2019

(30) Foreign Application Priority Data
Jun. 8, 2018 (JP) 2018-110653

(51) Int. Cl. G06Q 10/06; G06Q 30/02; G06N 20/00

(52) U.S. Cl. CPC G06Q 10/067; G06N 20/00; G06Q 10/06375; G06Q 30/0202

(57) ABSTRACT

An apparatus simulates checking action of checking, by an agent, a plurality of selection candidates in order for which expected values are set. Upon checking each of the plurality of selection candidates, the apparatus calculates an evaluated value of each selection candidate for the agent, and performs continuation judgment of determining whether the checking action is to be performed for a next one of the plurality of selection candidates, based on the expected values of unchecked selection candidates for which the checking action has not been performed yet and the evaluated values of checked selection candidates for which the checking action has been performed. Upon completion of checking a first selection candidate of the plurality of selection candidates, the apparatus modifies the expected values of the unchecked selection candidates, based on the evaluated value of the first selection candidate.

### CROSS-REFERENCE TO RELATED APPLICATION

This application is based upon and claims the benefit of priority of the prior Japanese Patent Application No. 2018-110653, filed on Jun. 8, 2018, the entire contents of which are incorporated herein by reference.

### FIELD

The embodiments discussed herein are related to simulation of information searching action changed with an anchor event.

### BACKGROUND

In layout design of tenants (hereinafter, also referred to as small facilities) in a facility such as a department store or a shopping mall, simulation of information searching action (hereinafter, also referred to as searching action) of human being is utilized. In this simulation, the tenants and a user agent (hereinafter, also referred to as agent) simulating a user are arranged in a virtual space corresponding to the facility such as the department store or the shopping mall. Flow of the user in the department store or the shopping mall is simulated by simulating the order of visiting the tenants by the agent.

It has been known that a person changes his(her) subsequent quantitative judgment with an initial proposed numerical value (anchoring and adjustment heuristics).

Japanese Laid-open Patent Publication Nos. 2016-218950, 2004-258762, and 8-22498 are examples of related art.

Tversky, A., & Kahneman, D., “Judgment under Uncertainty: Heuristics and Biases.”, Science, (1974), 185(4157), pp. 1124-1131 is another example of related art.

### SUMMARY

According to an aspect of the embodiments, an apparatus simulates checking action of checking, by an agent, a plurality of selection candidates in order for which expected values are set. Upon checking each of the plurality of selection candidates, the apparatus calculates an evaluated value of each selection candidate for the agent, and performs continuation judgment of determining whether the checking action is to be performed for a next one of the plurality of selection candidates, based on the expected values of unchecked selection candidates for which the checking action has not been performed yet and the evaluated values of checked selection candidates for which the checking action has been performed. Upon completion of checking a first selection candidate of the plurality of selection candidates, the apparatus modifies the expected values of the unchecked selection candidates, based on the evaluated value of the first selection candidate.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of the functional configuration of a simulation apparatus in an embodiment;

FIG. 2 is a diagram illustrating an example of searching action using expected values and actual evaluated values;

FIG. 3 is a diagram illustrating an example of change in the searching action, which is presumed in the real world;

FIG. 4 is a diagram illustrating an example of action when visiting an impressive small facility in simulation of the searching action using the expected values and the actual evaluated values;

FIG. 5 is a diagram illustrating an example of action when the searching action is changed using an anchor in the simulation;

FIG. 6 is a diagram illustrating another example of the action when the searching action is changed using the anchor in the simulation;

FIG. 7 is a diagram illustrating an example when the expected values are modified based on an anchor event;

FIG. 8 is a diagram illustrating an example of selection candidate information;

FIG. 9 is a diagram illustrating an example of the searching action when the expected values are modified based on the anchor event;

FIG. 10 is a diagram illustrating an example of modification of the expected values;

FIG. 11 is a diagram illustrating an example of reproduction of anchoring and adjustment heuristics;

FIG. 12 is a diagram illustrating an example of reproduction of reasonable shopping-around action;

FIG. 13 is a diagram illustrating an example when a ripple effect of in-store promotion is evaluated;

FIG. 14 is a diagram illustrating an example when cost-effectiveness of the in-store promotion is evaluated;

FIG. 15 is a flowchart illustrating an example of determination processing in the embodiment; and

FIG. 16 is a block diagram illustrating an example of the hardware configuration of the simulation apparatus in the embodiment.

### DESCRIPTION OF EMBODIMENTS

The above-described simulation simulates the flow of the user without considering change in the searching action of the user with an impressive event. It is therefore difficult to reproduce the change in the searching action with the impressive event.

It is preferable to reproduce the change in the searching action with the impressive event.

Hereinafter, an embodiment of a recording medium, a simulation method, and a simulation apparatus that are disclosed by the present application will be described in detail with reference to the drawings. The embodiment does not limit disclosed technology. The following embodiment may be appropriately combined in a consistent range.

### Embodiment

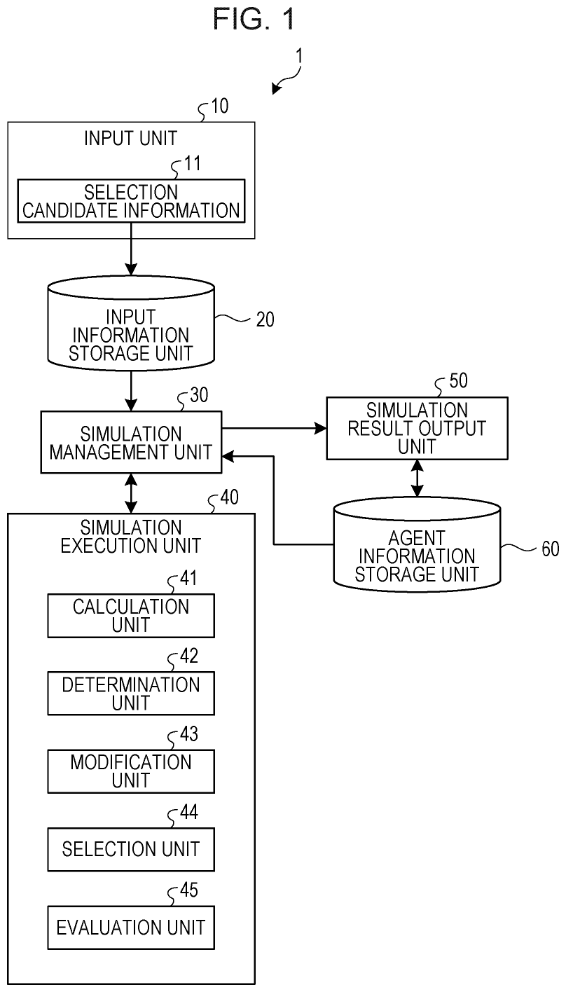

FIG. 1 is a block diagram illustrating an example of the functional configuration of a simulation apparatus in an embodiment. A simulation apparatus 1 illustrated in FIG. 1 is an information processing apparatus such as a personal computer (PC), for example. The simulation apparatus 1 performs checking action of checking, by an agent, a plurality of selection candidates in order for which expected values are respectively set. The simulation apparatus 1 calculates an evaluated value of the selection candidate for the agent every time the agent checks the selection candidate. The simulation apparatus 1 performs continuation judgment of the checking action based on the expected values of unchecked selection candidates and the evaluated value of the checked selection candidate every time the agent checks the selection candidate. The simulation apparatus 1 modifies the expected values of the unchecked selection candidates based on the evaluated value of the selection candidate after the agent finishes checking of at least any one of the plurality of selection candidates. The simulation apparatus 1 may thereby reproduce change in searching action with an impressive event.

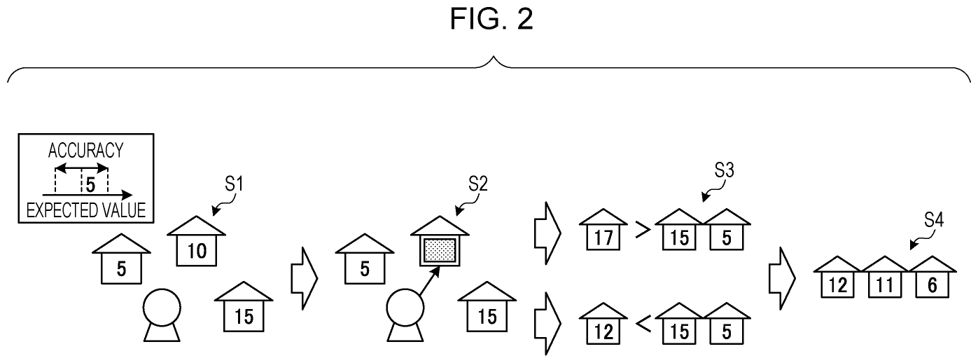

First, simulation of the searching action using the expected values and actual evaluated values, and an anchor event will be described with reference to FIGS. 2 to 7. FIG. 2 is a diagram illustrating an example of the searching action using the expected values and the actual evaluated values. As illustrated in FIG. 2, in the simulation of the searching action, expected values of small facilities in a certain facility are input (step S1). The expected value is an estimated satisfaction level for commercial products in a small facility and is a value having an average and dispersion. Then, in the simulation, a visit destination is decided based on preferences on the respective small facilities and temporal restriction. An actual evaluated value is calculated by visiting the decided visit destination (step S2). Subsequently, in the simulation, when the calculated actual evaluated value is higher than the expected values of all of unsearched small facilities and the other actual evaluated values, the searching is finished (step S3) and a commercial product in the small facility is purchased (step S4). When the calculated actual evaluated value is not higher than the expected values of all of the unsearched small facilities and the other actual evaluated values, the process returns to step S2 and a subsequent visit destination is decided. At step S3, when all of the candidate small facilities are searched, all of the actual evaluated values may be compared and a commercial product may be purchased while returning to the small facility having the highest value.

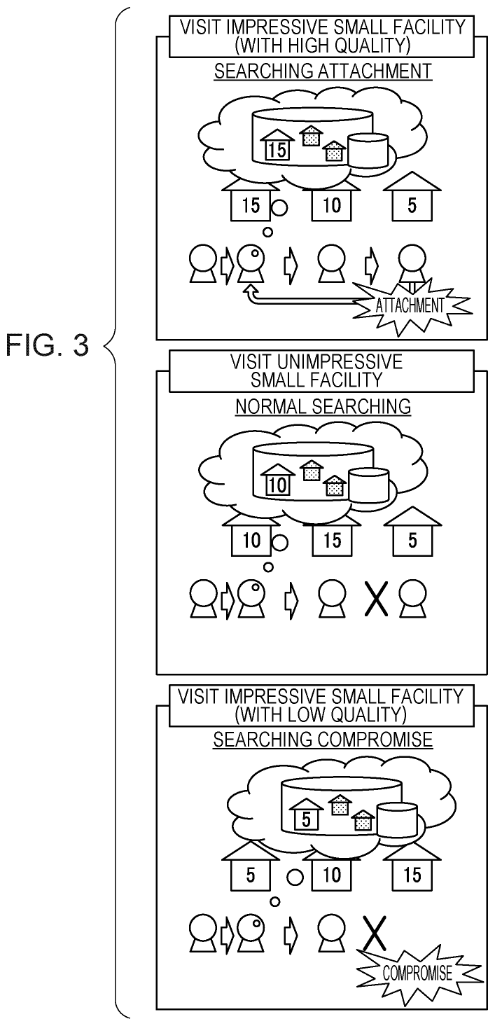

FIG. 3 is a diagram illustrating an example of change in the searching action, which is presumed in the real world. As illustrated in FIG. 3, the searching action of a user changes by change of purchase judgment action due to visit to an impressive small facility. For example, when the user visits an impressive small facility with high quality, which has the actual evaluated value of “15”, as a first store, the user is attached to searching and continues the searching even if no excellent small facility remains. For example, when the evaluated small facility has high quality, the user estimates that the other small facilities also have high quality, and walks around for a long time. When the user visits an unimpressive small facility, which has the actual evaluated value of “10”, as the first store, the user performs normal searching of searching for the small facility having the highest evaluated value. When the user visits an impressive small facility with low quality, which has the actual evaluated value of “5”, as the first store, the user compromises and stops the searching even if excellent small facilities remain. For example, when the evaluated small facility has low quality, the user estimates that the other small facilities also have low quality, and walks around for a short time. In this manner, a walking-around time is changed to be increased when the small facility that the user has visited first has high quality whereas it is changed to be decreased when the small facility that the user has visited first has low quality. In other words, for example, the searching action also changes by the change of the purchase judgment action of the user. For example, the change in the searching action illustrated in FIG. 3 corresponds to the anchoring and adjustment heuristics that the user changes his(her) subsequent quantitative judgment with an initial proposed numerical value.

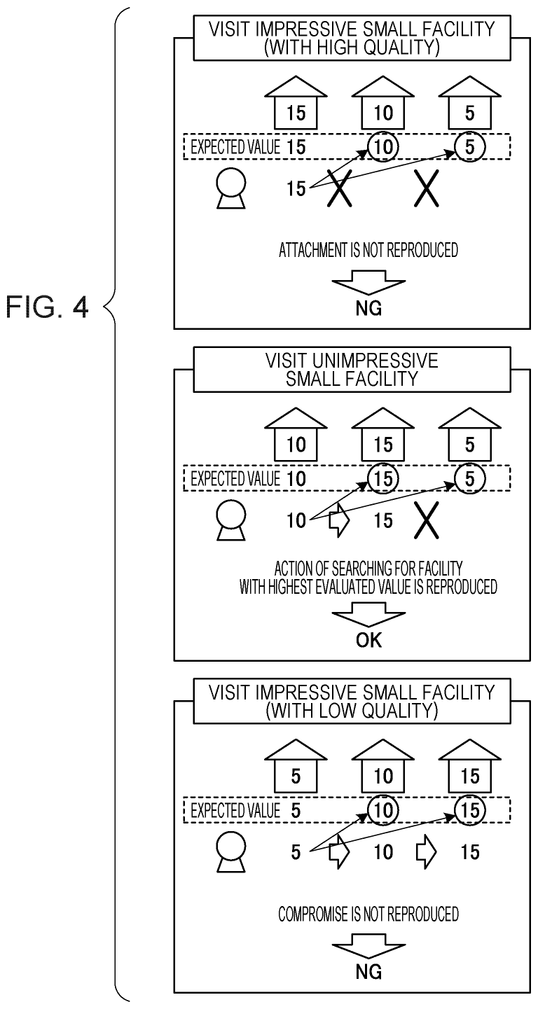

FIG. 4 is a diagram illustrating an example of action when visiting the impressive small facility in the simulation of the searching action using the expected values and the actual evaluated values. As illustrated in FIG. 4, in the simulation of the searching action in FIG. 2, even when visit to the impressive small facility is set as illustrated in FIG. 3, change in the searching action does not occur. In the example of FIG. 4, when the user visits the impressive small facility with high quality, which has the actual evaluated value of “15”, as the first store, the user finishes the searching with the first store and attachment is not reproduced because the actual evaluated value of the first store is “15” and the expected values of second and third stores are respectively “10” and “5”.

When the user visits the unimpressive small facility, which has the actual evaluated value of “10”, as the first store, the user performs the searching to the second store because the actual evaluated value of the first store is “10” and the expected value of the second store is “15”. The user finishes the searching with the second store because the actual evaluated value of the second store is “15” and the expected value of the third store is “5”. For example, when the user visits the unimpressive small facility as the first store, the reasonable shopping-around action of searching for the facility having the highest evaluated value is reproduced.

When the user visits the impressive small facility with low quality, which has the actual evaluated value of “5”, as the first store, the user first performs the searching to the second store because the actual evaluated value of the first store is “5” and the expected value of the second store is “10”. Then, the user performs the searching to the third store and compromise is not reproduced because the actual evaluated value of the second store is “10” and the expected value of the third store is “15”. For example, in the searching action using the expected values and the actual evaluated values as illustrated in FIG. 4, the impressive event does not cause change of the purchase judgment action and change in the searching action to occur.

On the other hand, the anchoring and adjustment heuristics proposes estimation of a best value from an anchor while a numerical value corresponding to the impressive event is set to the anchor. In this case, judgment action changes in conjunction with the anchor because judgment is made using the estimated best value. Examples of the impressive event include a visit to the first store, a visit to a store selling commercial products with high quality, and a visit to a store conducting a campaign or an event.

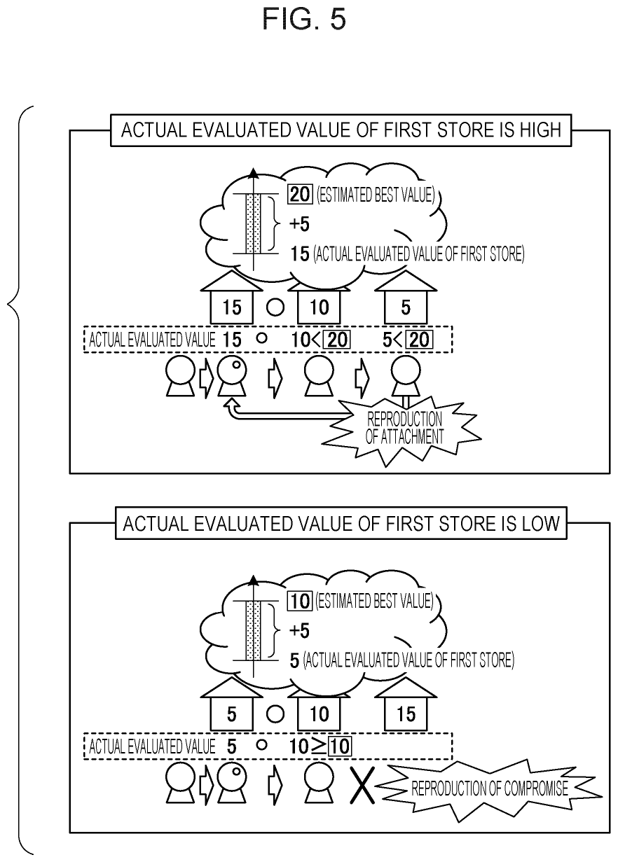

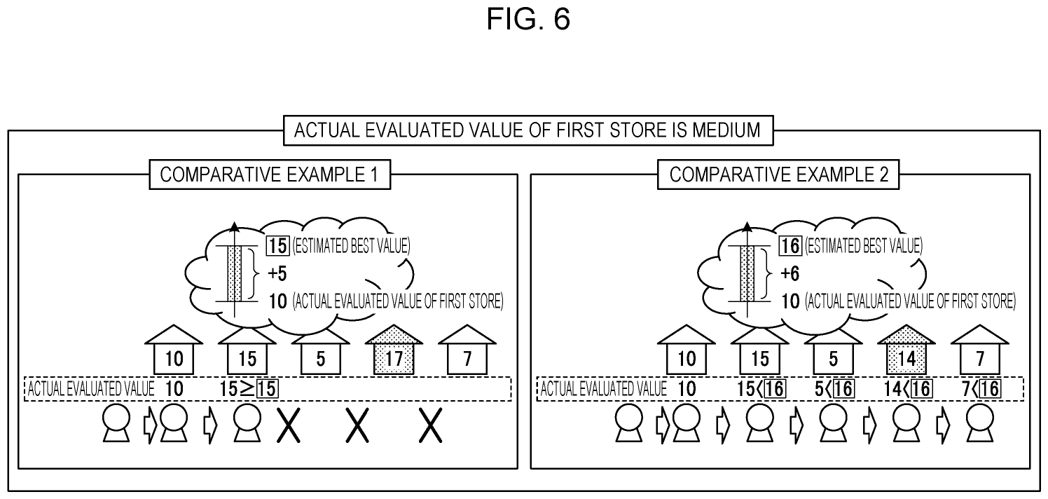

FIGS. 5 and 6 are diagrams illustrating an example of action when the searching action is changed using the anchor in the simulation. As illustrated in FIG. 5, when the actual evaluated value of the first store is set to the anchor and the estimated best value is set to “+5” of the anchor, the estimated best value is “20” in the case in which the actual evaluated value of the first store is as high as “15” and is impressive. The user compares the actual evaluated value “10” of the second store and the estimated best value “20” with each other and searches the third store because the actual evaluated value is lower than the estimated best value. Similarly, the user compares the actual evaluated value “5” of the third store and the estimated best value “20” with each other and returns to the first store having the highest actual evaluated value because the actual evaluated value is lower than the estimated best value. Thus, usage of the anchor may reproduce the attachment when the actual evaluated value of the first store is high and impressive.

When the actual evaluated value of the first store is as low as “5” and impressive, the estimated best value is “10”. The user compares the actual evaluated value “10” of the second store and the estimated best value “10” with each other and finishes the searching with the second store because the actual evaluated value is equal to or higher than the estimated best value. Thus, usage of the anchor may reproduce the compromise when the actual evaluated value of the first store is low and impressive.

As illustrated in FIG. 6, the case in which the actual evaluated value of the first store is medium is considered. In a “comparative example 1”, when the actual evaluated value of the first store is “10” being medium and is unimpressive, the estimated best value is “15” in the case in which the estimated best value is set to “+5” of the anchor. The user compares the actual evaluated value “15” of the second store and the estimated best value of “15” with each other and finishes the searching with the second store because the actual evaluated value is equal to or higher than the estimated best value. There is however a fourth store having the actual evaluated value “17”. In this case, the reasonable shopping-around action of trying to find the facility having the highest actual evaluated value is not reproduced.

It is also considered that the reasonable shopping-around action is reproduced by adjusting a distance of the estimated best value (“+5” in the “comparative example 1” in FIG. 6). With the adjustment of the distance of the estimated best value, increase in the distance enlarges a search range and decrease in the distance narrows the search range. In the “comparative example 1”, the facility having the highest actual evaluated value is found by adjusting the distance of the estimated best value to “+6”. However, with the above-described adjustment of the distance of the estimated best value, a pattern that the reasonable shopping-around action is not preferably reproduced occurs depending on the expected values of the small facilities.

For example, as indicated in a “comparative example 2” in FIG. 6, when the actual evaluated value of the fourth store is “14”, searching is continued to a fifth store in the case in which the distance of the estimated best value is set to “+6”. Thus, in the “comparative example 2”, the reasonable shopping-around action that the searching is finished with the second store having the actual evaluated value of “15” is not reproduced. Accordingly, with the adjustment of the distance of the estimated best value to “+6”, the reasonable shopping-around action in the “comparative example 2” fails even when the reasonable shopping-around action in the “comparative example 1” is reproduced.

As described above, the searching action using the expected values and the actual evaluated values as illustrated in FIG. 4 involves comparison between all combinations and therefore causes the reasonable shopping action of searching for the facility having the highest evaluated value to occur. However, the searching action using the expected values and the actual evaluated values does not cause the change of the judgment action with the impressive event. On the other hand, the method of changing the searching action using the anchor as illustrated in FIGS. 5 and 6 involves comparison between each pair and therefore reproduces the change of the purchase judgment by change of the estimated value in conjunction with the impressive event. The method of changing the searching action using the anchor does not however involve the comparison between all combinations and does not therefore cause the reasonable shopping action.

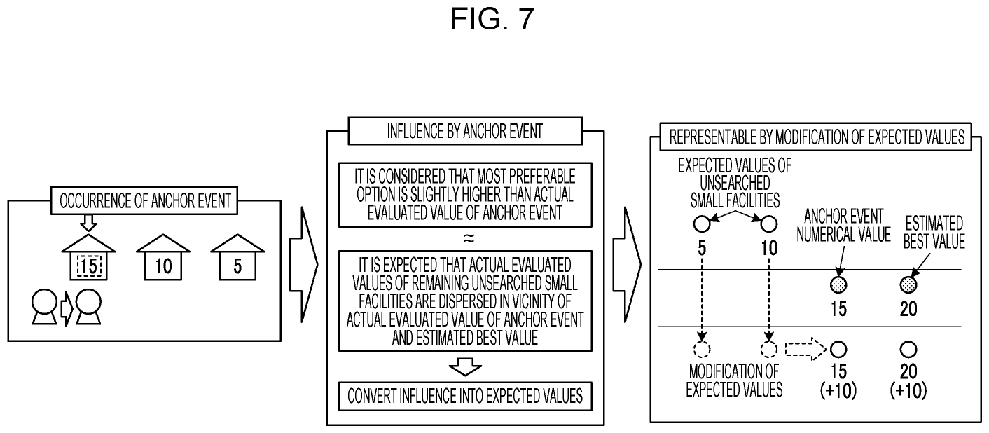

It is then considered that the purchase judgment action is changed within the framework of the searching action based on the comparison between the expected values and the actual evaluated values, which involves the comparison between all combinations. FIG. 7 is a diagram illustrating an example when the expected values are modified based on the anchor event. As illustrated in FIG. 7, the anchor event that the actual evaluated value is “15” is assumed to occur in the first store. Influence on the purchase judgment action by the anchor event may be considered that, for example, the most preferable option is slightly higher than the actual evaluated value of the anchor event. For example, it may be expected that the actual evaluated values of the remaining unsearched small facilities are dispersed in the vicinity of the actual evaluated value of the anchor event and the estimated best value. For example, the influence by the anchor event may be converted into the expected value.

In the example of FIG. 7, the influences by the anchor event may be represented by modifying the expected values “5” and “10” of the unsearched small facilities so as to add “+10” thereto in the simulation. For example, the expected values “15” and “20” obtained by recalculation represent the influence by the anchor event.

Subsequently, the configuration of the simulation apparatus 1 will be described. As illustrated in FIG. 1, the simulation apparatus 1 includes an input unit 10, an input information storage unit 20, a simulation management unit 30, a simulation execution unit 40, a simulation result output unit 50, and an agent information storage unit 60.

The input unit 10 receives input information related to simulation, such as selection candidate information 11, by, for example, an input device such as a mouse, a keyboard, or the like.

The input information storage unit 20 stores the input information such as the selection candidate information 11 input by the input unit 10 in a storage device such as a random access memory (RAM), a hard disk drive (HDD), or the like.

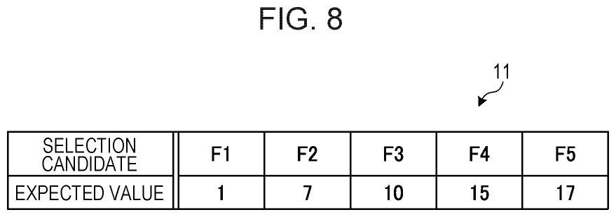

The selection candidate information 11 is information that correlates selection candidates corresponding to small facilities in a facility and expected values of the small facilities with each other. FIG. 8 is a diagram illustrating an example of the selection candidate information. The input unit 10 receives input of information that correlates selection candidate aggregation and the expected values of the selection candidates with each other, as described in FIG. 8. The selection candidate aggregation represents the small facilities using identifiers (IDs) such as F1 and F2. The expected value represents an estimated satisfaction level for commercial products and has an average and dispersion. The example of FIG. 8 illustrates the expected value when the dispersion is 0 for simplification.

The simulation management unit 30 manages processing of simulating the searching action of the user of the facility, the simulation execution unit 40 executing the processing. For example, the simulation management unit 30 and the simulation execution unit 40 execute simulation of the action of checking, by the agent, the plurality of selection candidates in order for which the expected values are set for each.

The simulation management unit 30 reads the input information stored in the input information storage unit 20 and an interim process (actual evaluated values and modified expected values of stores) of the simulation, which is stored in the agent information storage unit 60, in accordance with progress of the simulation that the simulation execution unit 40 executes. The simulation management unit 30 outputs the read contents to the simulation execution unit 40. The simulation management unit 30 outputs, to the simulation result output unit 50, a result of sequential simulation of user's action by the simulation execution unit 40.

The simulation management unit 30 extracts one unchecked selection candidate (small facility) from the selection candidate aggregation in accordance with the progress of the simulation and outputs it to the simulation execution unit 40. The simulation management unit 30 decides a visit destination based on, for example, a layout of the facility, user's preferences on the small facilities, and temporal restriction. The simulation management unit 30 extracts the unchecked selection candidate as the decided visit destination and outputs it to the simulation execution unit 40.

When a selection unit 44, which will be described later, stores the decided selection candidate in the agent information storage unit 60, the simulation management unit 30 moves the agent to the decided selection candidate and decides purchase in the small facility of the selection candidate. The simulation management unit 30 outputs the movement of the agent and the purchase result to the simulation result output unit 50.

The simulation execution unit 40 sequentially simulates the evaluated values when the user of the facility actually visits the small facilities. The simulation execution unit 40 modifies the expected values when the anchor event occurs and determines next action to be performed by the user based on the modified expected values and the actual evaluated values. For example, the simulation execution unit 40 determines whether to check the unchecked small facility or select one small facility from the checked small facilities. The simulation execution unit 40 outputs the simulation result to the simulation management unit 30.

The simulation execution unit 40 includes a calculation unit 41, a determination unit 42, a modification unit 43, the selection unit 44, and an evaluation unit 45.

The calculation unit 41 calculates the actual evaluated value for the selection candidate input from the simulation management unit 30. The calculation unit 41 calculates the actual evaluated value stochastically based on the average and dispersion of the expected values while the expected values have a normal distribution, for example. The calculation unit 41 outputs the calculated actual evaluated value to the simulation result output unit 50. For example, the calculation unit 41 calculates the evaluated value of the selection candidate for the agent every time the agent (user) checks the selection candidate (small facility).

The determination unit 42 determines whether all of the selection candidates (small facilities) have been checked. When the determination unit 42 determines that all of the selection candidates have not been checked, it performs continuation judgment of the checking action based on the actual evaluated values and the expected values. For example, the determination unit 42 determines whether to finish the searching of the small facilities based on the actual evaluated values and the expected values. The determination unit 42 determines to finish the searching of the small facilities when the actual evaluated value of the extracted selection candidate is higher than all of the expected values and all of the other actual evaluated values in the determination. When there is the expected value or another actual evaluated value being equal to or higher than the actual evaluated value of the extracted selection candidate, the determination unit 42 determines to continue the searching of the small facilities and instructs the modification unit 43 to determine the anchor event.

When the determination unit 42 determines to finish the searching of the small facilities, it outputs a selection instruction to the selection unit 44. Also when the determination unit 42 determines that all of the selection candidates have been checked, it outputs the selection instruction to the selection unit 44.

In other words, the determination unit 42 performs the continuation judgment of the checking action based on the expected values of the unchecked selection candidates and the evaluated values of the checked selection candidates every time the agent checks the selection candidate. The determination unit 42 judges to finish the checking action when a maximum value of the evaluated values of the checked selection candidates is higher than a maximum value of the expected values of the unchecked selection candidates. The determination unit 42 judges to continue the checking action when the maximum value of the evaluated values of the checked selection candidates is lower than the maximum value of the expected values of the unchecked selection candidates.

When the modification unit 43 receives the instruction to determine the anchor event from the determination unit 42, it determines whether there is the anchor event. The anchor event is, for example, checking of the first selection candidate, an in-store campaign, the number of the checked selection candidates, a period of time during which the agent stays in the facility having the plurality of selection candidates, a walking-around distance of the agent, passage of a predetermined period of time, or a combination thereof. When the modification unit 43 determines that there is the anchor event, it modifies the expected values of the unchecked selection candidates, for example, the expected values of the unsearched small facilities based on the actual evaluated value of the selection candidate. The modification unit 43 outputs the modified expected values to the simulation result output unit 50. When the modification unit 43 determines that there is no anchor event, it does not modify the expected values of the unchecked selection candidates. The modification unit 43 instructs the simulation management unit 30 to extract the next unchecked selection candidate after the determination of the anchor event.

In other words, the modification unit 43 modifies the expected values of the unchecked selection candidates based on the evaluated value of the selection candidate after the agent finishes checking of at least any one of the plurality of selection candidates. The modification unit 43 modifies the expected values of the unchecked selection candidates based on the evaluated value of the selection candidate when the anchor event as the impressive event for the agent occurs. The modification unit 43 modifies such that a relatively large value is added to each of the expected values of the unchecked selection candidates as the evaluated value of the selection candidate is relatively higher than distribution of the expected values of the unchecked selection candidates. The modification unit 43 modifies such that a relatively large value is subtracted from each of the expected values of the unchecked selection candidates as the evaluated value of the selection candidate is relatively lower than the distribution of the expected values of the unchecked selection candidates.

When the selection unit 44 receives the selection instruction input from the determination unit 42, it decides the selection candidate based on the actual evaluated values with reference to the agent information storage unit 60. The selection unit 44 outputs the decided selection candidate to the simulation result output unit 50.

The evaluation unit 45 acquires the expected values (including the modified expected values) and the actual evaluated values of the small facilities for the agent from the agent information storage unit 60 through the simulation management unit 30. Thus, the acquired expected values and actual evaluated values are a plurality of patterns of the expected values and the actual evaluated values when the evaluated value corresponding to the anchor event is changed.

The evaluation unit 45 evaluates a ripple effect indicating increase in walking-around promotion based on the plurality of patterns of the expected values and the actual evaluated values. The evaluation unit 45 derives cost-effectiveness and rebates of the small facilities based on the ripple effect and cost for the anchor event. The evaluation unit 45 outputs an evaluation result such as the ripple effect, the cost-effectiveness, the rebates, or the like to the simulation result output unit 50 through the simulation management unit 30. For example, the evaluation unit 45 evaluates the ripple effect of the anchor event using a result of the continuation judgment of the checking action.

The simulation result output unit 50 stores, in the agent information storage unit 60, the expected values (including modified expected values), the actual evaluated values, the decided selection candidate, the movement and purchase result of the agent, and the evaluation result. The simulation result output unit 50 displays, on a display device such as a monitor, a printer, or the like, the expected values (including modified expected values), the actual evaluated values, the decided selection candidate, the movement and purchase result of the agent, and the evaluation result. It is to be noted that the simulation result output unit 50 may sequentially output a simulation result. The simulation result output unit 50 may output a collected result of the results obtained by the simulation for a predetermined period of time.

The agent information storage unit 60 stores, in a storage device such as a RAM and an HDD, the expected values (including modified expected values), the actual evaluated values, the decided selection candidate, the movement and purchase result of the agent, the evaluation result, and the like obtained by the simulation.

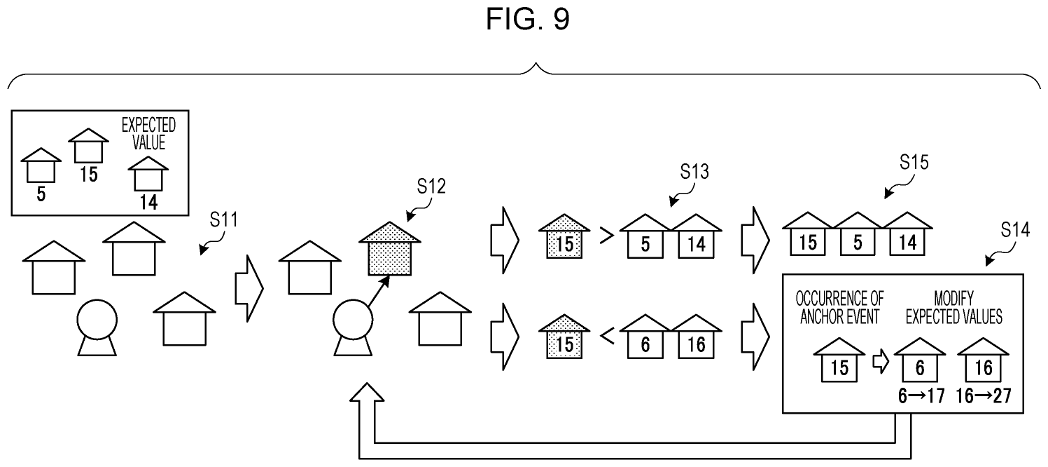

Modification of the expected values based on the anchor event will be described with reference to FIGS. 9 to 12. FIG. 9 is a diagram illustrating an example of the searching action when the expected values are modified based on the anchor event. As illustrated in FIG. 9, the simulation apparatus 1 sets the expected values of commercial products placed in each of the small facilities based on the selection candidate information 11 (step S11).

The simulation apparatus 1 decides the visit destination based on the previously set layout of the facility, the user's preferences on the small facilities, and the temporal restriction. The simulation management unit 30 extracts the unchecked selection candidate as the decided visit destination and calculates the actual evaluated value (step S12).

When there is the expected value or another actual evaluated value which is equal to or higher than the actual evaluated value of the extracted selection candidate, the simulation apparatus 1 proceeds to step S14 and modifies the expected values based on the anchor event. On the other hand, when the actual evaluated value of the extracted selection candidate is higher than all of the expected values and all of the other actual evaluated values, the simulation apparatus 1 determines to finish the searching of the small facilities (step S13) and proceeds to step S15.

When the simulation apparatus 1 determines that there is the expected value or another actual evaluated value which is equal to or higher than the actual evaluated value of the extracted selection candidate at step S13, it determines whether there is the anchor event (step S14). When the simulation apparatus 1 determines that there is the anchor event, it modifies the expected values of the remaining small facilities based on the actual evaluated value of the extracted selection candidate, returns to step S12, and continues the searching of the small facilities. On the other hand, when the simulation apparatus 1 determines that there is no anchor event, it returns to step S12 without modifying the expected values of the remaining small facilities and continues the searching of the small facilities.

When the simulation apparatus 1 determines to finish the searching of the small facilities at step S13, it decides the selection candidate based on the actual evaluated values. The simulation apparatus 1 moves the agent to the decided selection candidate and decides purchase in the small facility of the selection candidate (step S15). Thus, the simulation apparatus 1 may simulate flow of purchasing, by the user, the commercial product in the small facility decided based on the expected values modified by the impressive event.

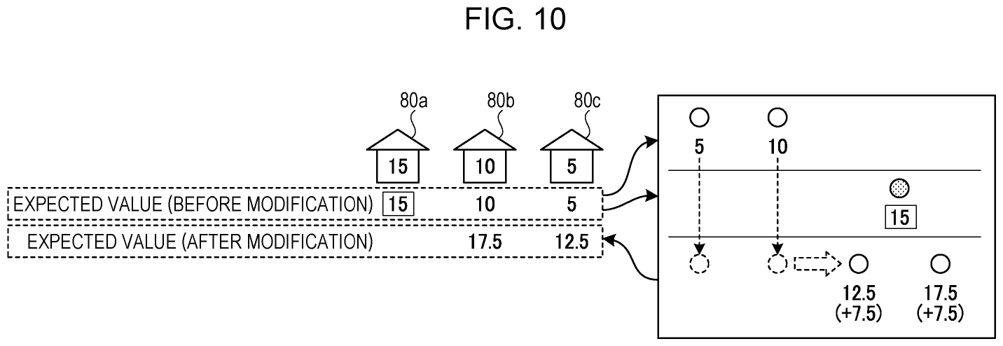

FIG. 10 is a diagram illustrating an example of modification of the expected values. As illustrated in FIG. 10, as an example of a method for modifying the expected values, a method for modifying them while the actual evaluated value corresponding to the anchor event is assumed to be the estimated best value may be employed. In this case, the modification unit 43 modifies such that the actual evaluated value corresponding to the anchor event is identical to an average of distribution of the expected values of the remaining unsearched small facilities, as a modification manner of the expected values.

In FIG. 10, the expected values of small facilities 80a to 80c before modification are “15”, “10”, and “5”, respectively. When the anchor event is a visit to the small facility 80a as a first store, the modification unit 43 adds “the actual evaluated value of the small facility 80a—an average of the expected values of the unsearched small facilities” to the expected values of the small facilities 80b and 80c as the unsearched small facilities for modification. For example, an added value is 15−(10+5)/2=7.5. Accordingly, the expected values of the small facilities 80b and 80c after modification are respectively “17.5” and “12.5”. The modification unit 43 may achieve both of reproduction of the anchoring and adjustment heuristics and reproduction of the reasonable shopping-around action by modifying the expected values in this manner.

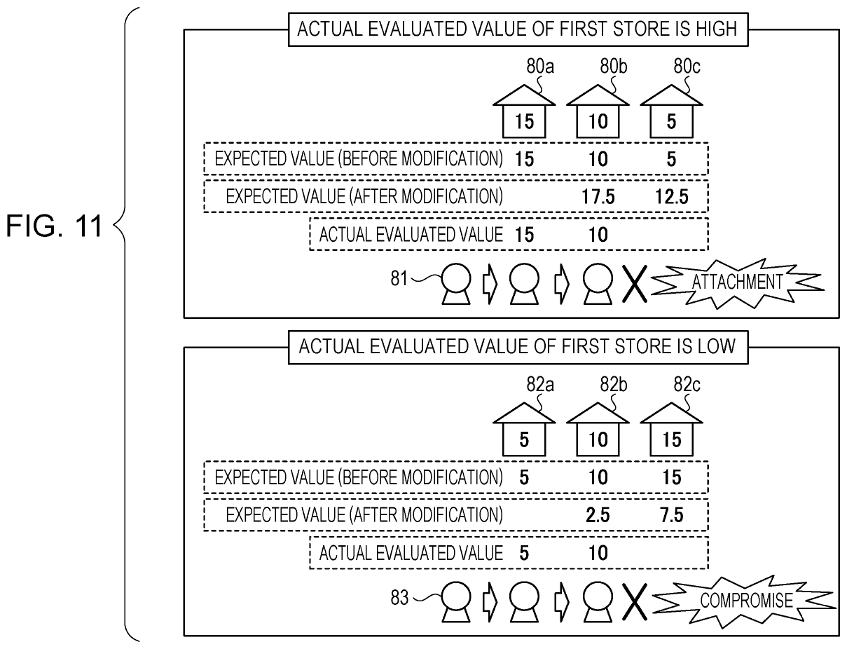

FIG. 11 is a diagram illustrating an example of the reproduction of the anchoring and adjustment heuristics. In FIG. 11, the anchor event is assumed to be visit to the first store. First, the case in which the actual evaluated value of the first store is high will be described. In this case, it is assumed that an agent 81 visits the small facilities 80a to 80c in this order, the actual evaluated value of the small facility 80a as the first store is “15”, and the expected values of the small facilities 80b and 80c before modification are respectively “10” and “5”. When the modification unit 43 modifies the expected values of the small facilities 80b and 80c based on the actual evaluated value “15” of the small facility 80a for the agent 81 in the same manner as the case of FIG. 10, the expected value of the small facility 80b is “17.5” and the expected value of the small facility 80c is “12.5”. The agent 81 visits the small facility 80b having the expected value after modification, which is higher than the actual evaluated value “15” of the small facility 80a, thereby reproducing the attachment of the searching.

Then, the case in which the actual evaluated value of the first store is low will be described using small facilities 82a to 82c. In this case, it is assumed that an agent 83 visits the small facilities 82a to 82c in this order, the actual evaluated value of the small facility 82a as the first store is “5”, and the expected values of the small facilities 82b and 82c before modification are respectively “10” and “15”. The modification unit 43 modifies the expected values of the small facilities 82b and 82c such that the actual evaluated value “5” of the small facility 82a for the agent 83 is identical to an average of distribution of the expected values of the small facilities 82b and 82c. The modification unit 43 subtracts difference “7.5” between the average “12.5” of the distribution of the expected values of the small facilities 82b and 82c and the actual evaluated value “5” of the small facility 82a from the expected values of the small facilities 82b and 82c. As a result, the expected value of the small facility 82b is “2.5” and the expected value of the small facility 82c is “7.5”. The agent 83 then visits the next small facility 82b because there is the small facility 82c having the expected value after modification, which is higher than the actual evaluated value “5” of the small facility 82a. The agent 83 decides purchase in the small facility 82b because the actual evaluated value of the small facility 82b is “10” and the expected value of the small facility 82c after modification is “7.5”, thereby reproducing the compromise of the searching.

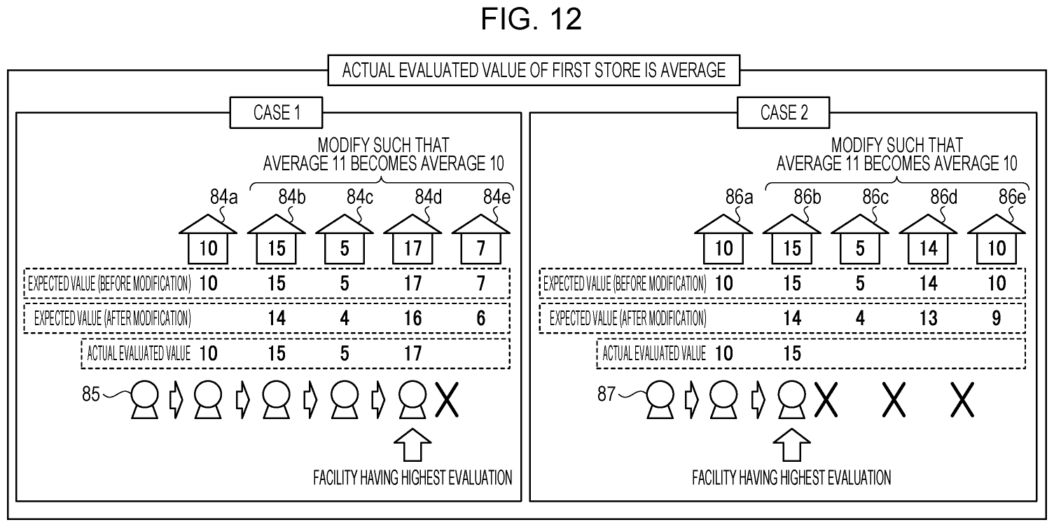

Subsequently, the case in which the actual evaluated value of the first store is average will be described with reference to FIG. 12. FIG. 12 is a diagram illustrating an example of the reproduction of the reasonable shopping-around action. In FIG. 12, the anchor event is assumed to be a visit to the first store. In the “case 1” in FIG. 12, description is made using small facilities 84a to 84e. In this case, it is assumed that an agent 85 visits the small facilities 84a to 84e in this order, the actual evaluated value of the small facility 84a as the first store is “10”, and the expected values of the small facilities 84b to 84e before modification are respectively “15”, “5”, “17”, and “7”. The modification unit 43 modifies the expected values of the small facilities 84b to 84e such that the actual evaluated value “10” of the small facility 84a for the agent 85 is identical to an average of distribution of the expected values of the small facilities 84b to 84e. The modification unit 43 subtracts difference “1” between the average “11” of the distribution of the expected values of the small facilities 84b to 84e and the actual evaluated value “10” of the small facility 84a from the expected values of the small facilities 84b to 84e. As a result, the expected values of the small facilities 84b to 84e after modification are respectively “14”, “4”, “16”, and “6”. The agent 85 compares the actual evaluated values and the expected values after modification in the order from the small facility 84a and visits the small facilities to the small facility 84d having the highest value. The agent 85 then decides purchase in the small facility 84d, thereby reproducing the reasonable shopping-around action.

In the “case 2” in FIG. 12, description is made using small facilities 86a to 86e. In this case, it is assumed that an agent 87 visits the small facilities 86a to 86e in this order, the actual evaluated value of the small facility 86a as the first store is “10”, and the expected values of the small facilities 86b to 86e before modification are respectively “15”, “5”, “14”, and “10”. The modification unit 43 modifies the expected values of the small facilities 86b to 86e such that the actual evaluated value “10” of the small facility 86a for the agent 87 is identical to an average of distribution of the expected values of the small facilities 86b to 86e. The modification unit 43 subtracts difference “1” between the average “11” of the distribution of the expected values of the small facilities 86b to 86e and the actual evaluated value “10” of the small facility 86a from the expected values of the small facilities 86b to 86e. As a result, the expected values of the small facilities 86b to 86e after modification are respectively “14”, “4”, “13”, and “9”. The agent 87 compares the actual evaluated values and the expected values after modification in the order from the small facility 86a and visits the small facilities up to the small facility 86b having the highest value. The agent 87 then decides purchase in the small facility 86b, thereby reproducing the reasonable shopping-around action.

In FIGS. 10 to 12, the modification unit 43 modifies such that the average value of the distribution of the expected values of the unchecked selection candidates is equal to the evaluated value of the selection candidate. However, the modification unit 43 is not limited to modify in this manner. For example, the modification unit 43 may calculate an estimated best value based on the evaluated value of the selection candidate and modify such that the average value of the distribution of the expected values of the unchecked selection candidates is equal to the calculated estimated best value. Alternatively, for example, the modification unit 43 may modify such that a median or a mode of the distribution of the expected values of the unchecked selection candidates is equal to the evaluated value of the selection candidate. As still another example, the modification unit 43 may calculate the estimated best value based on the evaluated value of the selection candidate and modify such that the average value of the distribution of the expected values of the unchecked selection candidates is equal to an intermediate value between the evaluated value of the selection candidate and the calculated estimated best value.

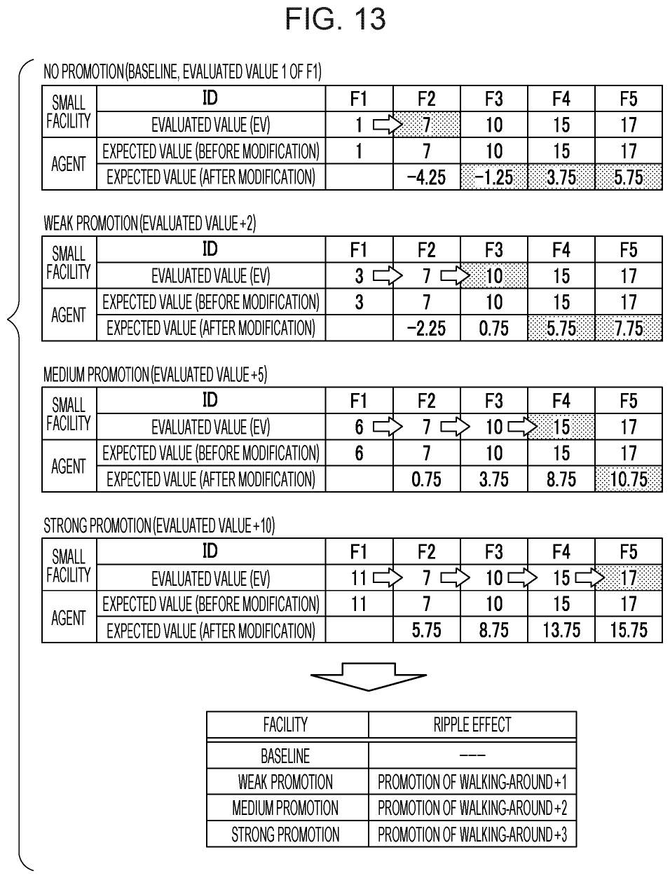

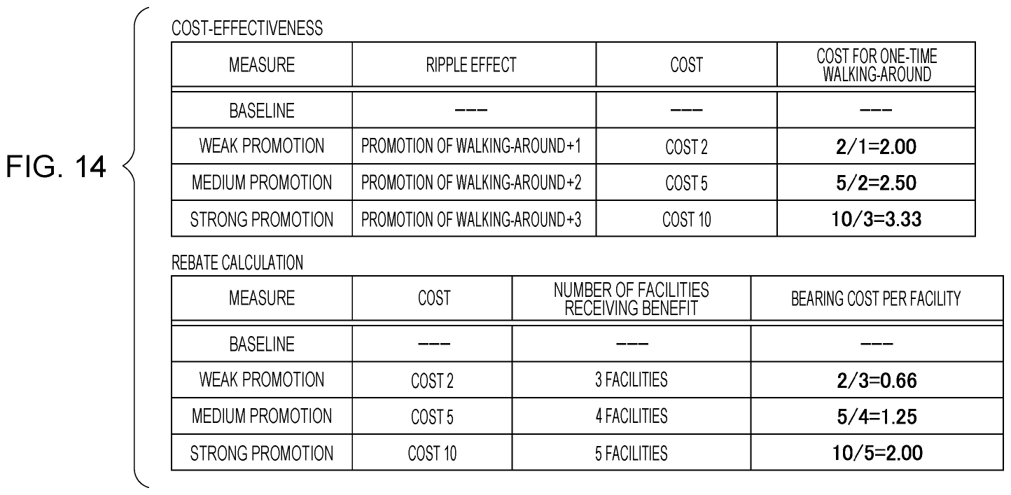

Next, an effect of in-store promotion as an example of the anchor event will be described with reference to FIGS. 13 and 14. FIG. 13 is a diagram illustrating an example when a ripple effect of the in-store promotion is evaluated. FIG. 13 describes the case in which the evaluation unit 45 evaluates the ripple effect when the in-store promotion of a plurality of levels (weak, medium, and strong) as the anchor event is executed in a small facility F1 on the entrance side among a plurality of small facilities F1 to F5 in a certain facility, for example. In FIG. 13, it is assumed that expected values before modification for the agent are equal to evaluated values (EV).

First, a baseline is set to the case with no promotion. In this case, the evaluated values (EV) of the small facilities F1 to F5 are assumed to be respectively “1”, “7”, “10”, “15”, and “17”. When an agent visits the small facility F1, the modification unit 43 modifies the expected values of the small facilities F2 to F5 such that the evaluated value “1” of the small facility F1 is identical to an average of distribution of the expected values of the small facilities F2 to F5. The modification unit 43 subtracts difference “11.25” between the average “12.25” of the distribution of the expected values of the small facilities F2 to F5 and the actual evaluated value “1” of the small facility F1 from the expected values of the small facilities F2 to F5. As a result, the expected values of the small facilities F2 to F5 after modification are respectively “−4.25”, “−1.25”, “3.75”, and “5.75”. When the evaluated values (EV) are compared with the expected values after modification in the order from the small facility F1, the evaluated value (EV) of the small facility F2 is higher than the expected values of the small facilities F3 to F5 after modification. Therefore, the agent visits the small facilities up to the small facility F2.

The weak promotion is set to the case in which the evaluated value of the small facility F1 is “+2”. In this case, when comparing with the baseline, the evaluated value (EV) of the small facility F1 is “3” and the evaluated values (EV) of the small facilities F2 to F5 are the same as those of the baseline. When the agent visits the small facility F1, the modification unit 43 modifies the expected values of the small facilities F2 to F5 such that the evaluated value “3” of the small facility F1 is identical to the average of the distribution of the expected values of the small facilities F2 to F5. The modification unit 43 subtracts difference “9.25” between the average “12.25” of the distribution of the expected values of the small facilities F2 to F5 and the actual evaluated value “3” of the small facility F1 from the expected values of the small facilities F2 to F5. As a result, the expected values of the small facilities F2 to F5 after modification are respectively “−2.25”, “0.75”, “5.75”, and “7.75”. When the evaluated values (EV) are compared with the expected values after modification in the order from the small facility F1, the evaluated value (EV) of the small facility F3 is higher than the expected values of the small facilities F4 and F5 after modification. Therefore, the agent visits the small facilities to the small facility F3. It is therefore said that the weak promotion provides the ripple effect of increasing the walking-around promotion by “1” in comparison with that of the baseline.

The medium promotion is set to the case in which the evaluated value of the small facility F1 is “+5”. In this case, when comparing with the baseline, the evaluated value (EV) of the small facility F1 is “6” and the evaluated values (EV) of the small facilities F2 to F5 are the same as those of the baseline. When the agent visits the small facility F1, the modification unit 43 modifies the expected values of the small facilities F2 to F5 such that the evaluated value “6” of the small facility F1 is identical to the average of the distribution of the expected values of the small facilities F2 to F5. The modification unit 43 subtracts difference “6.25” between the average “12.25” of the distribution of the expected values of the small facilities F2 to F5 and the actual evaluated value “6” of the small facility F1 from the expected values of the small facilities F2 to F5. As a result, the expected values of the small facilities F2 to F5 after modification are respectively “0.75”, “3.75”, “8.75”, and “10.75”. When the evaluated values (EV) are compared with the expected values after modification in the order from the small facility F1, the evaluated value (EV) of the small facility F4 is higher than the expected value of the small facility F5 after modification. Therefore, the agent visits the small facilities up to the small facility F4. It is therefore said that the medium promotion provides the ripple effect of increasing the walking-around promotion by “2” in comparison with that of the baseline.

The strong promotion is set to the case in which the evaluated value of the small facility F1 is “+10”. In this case, when comparing with the baseline, the evaluated value (EV) of the small facility F1 is “11” and the evaluated values (EV) of the small facilities F2 to F5 are the same as those of the baseline. When the agent visits the small facility F1, the modification unit 43 modifies the expected values of the small facilities F2 to F5 such that the evaluated value “11” of the small facility F1 is identical to the average of the distribution of the expected values of the small facilities F2 to F5. The modification unit 43 subtracts difference “1.25” between the average “12.25” of the distribution of the expected values of the small facilities F2 to F5 and the actual evaluated value “11” of the small facility F1 from the expected values of the small facilities F2 to F5. As a result, the expected values of the small facilities F2 to F5 after modification are respectively “5.75”, “8.75”, “13.75”, and “15.75”. When the evaluated values (EV) are compared with the expected values after modification in the order from the small facility F1, the evaluated value (EV) of the small facility F4 is lower than the expected value of the small facility F5 after modification. Therefore, the agent visits the small facilities up to the small facility F5. It is therefore said that the strong promotion provides the ripple effect of increasing the walking-around promotion by “3” in comparison with that of the baseline.

FIG. 14 is a diagram describing an example when the cost-effectiveness of the in-store promotion is evaluated. FIG. 14 describes an example of the cost-effectiveness and rebate calculation in the example of FIG. 13. In FIG. 14, as for cost, when cost for increasing the evaluated value (EV) of the small facility F1 by “1” is assumed to be, for example, “cost 1”, the weak promotion requires “cost 2”, the medium promotion requires “cost 5”, and the strong promotion requires “cost 10”. Cost for one-time walking-around (increase for one small facility) is “2.00” for the weak promotion, “2.50” for the medium promotion, and “3.33” for the strong promotion based on the ripple effect and the cost.

The calculation of the rebate as bearing cost per facility is “0.66” for the weak promotion, “1.25” for the medium promotion, and “2.00” for the strong promotion based on the cost and the number of facilities receiving benefit of the in-store promotion. The evaluation unit 45 thus derives the ripple effect, the cost-effectiveness, and the rebate amount of the in-store promotion. For example, the evaluation unit 45 may evaluate influences on walking-around in an overall complex facility by the measure of holding the anchor event (for example, the in-store promotion). The evaluation unit 45 may evaluate the ripple effects by individual measures which are individually held by the small facilities and calculate the cost-effectiveness of the small facilities and the rebates for the small facilities that have held the measures.

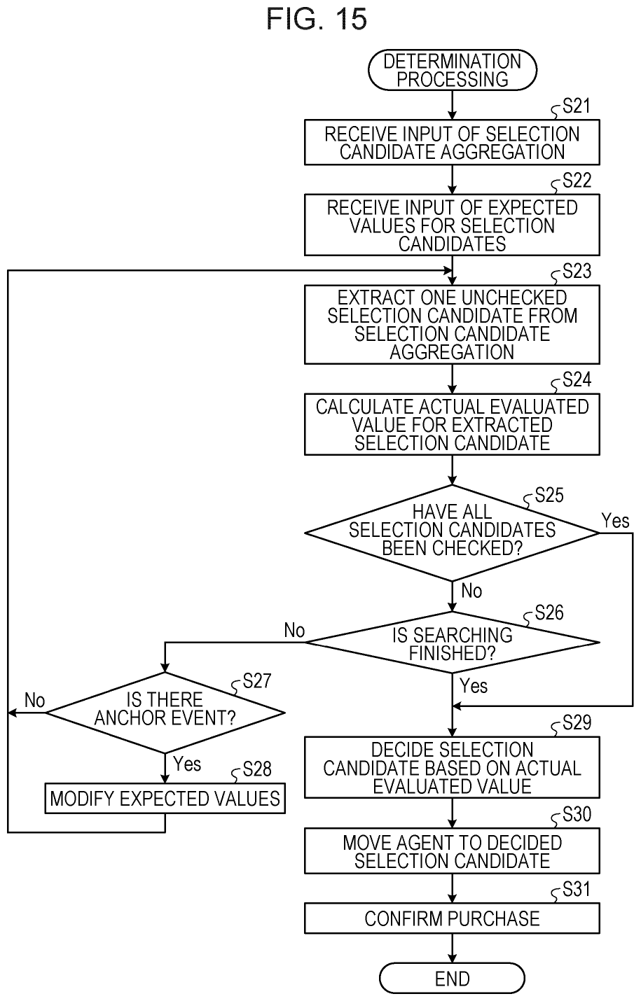

Next, operations of the simulation apparatus 1 in the embodiment will be described. FIG. 15 is a flowchart illustrating an example of the determination processing in the embodiment.

The input unit 10 of the simulation apparatus 1 receives input of the selection candidate information 11, for example, selection candidate aggregation and input of expected values of each of selection candidates when the processing is started (steps S21 and S22). The input unit 10 stores the received selection candidate information 11 in the input information storage unit 20.

The simulation management unit 30 extracts one unchecked selection candidate from the selection candidate aggregation in accordance with progress of simulation and outputs it to the simulation execution unit 40 (step S23).

The calculation unit 41 calculates an actual evaluated value of the selection candidate input from the simulation management unit 30, which is the extracted selection candidate (step S24). The calculation unit 41 outputs the calculated actual evaluated value to the simulation result output unit 50.

The determination unit 42 determines whether all of the selection candidates have been checked (step S25). When the determination unit 42 determines that all of the selection candidates have not been checked (No at step S25), it determines whether searching of small facilities is finished based on the actual evaluated values and the expected values (step S26). When the determination unit 42 determines that the searching of the small facilities is not finished (No at step S26), it instructs the modification unit 43 to determine an anchor event.

When the modification unit 43 receives the instruction to determine the anchor event from the determination unit 42, it determines whether there is the anchor event (step S27). When the modification unit 43 determines that there is the anchor event (Yes at step S27), it modifies the expected values of the unchecked selection candidates based on the actual evaluated value of the selection candidate (step S28). The modification unit 43 outputs the modified expected values to the simulation result output unit 50. The modification unit 43 instructs the simulation management unit 30 to extract the next unchecked selection candidate and returns to step S23.

When the modification unit 43 determines that there is no anchor event (No at step S27), it instructs the simulation management unit 30 to extract the next unchecked selection candidate without modifying the expected values of the unchecked selection candidates and returns to step S23.

When the determination unit 42 determines that all of the selection candidates have been checked (Yes at step S25) or determines that the searching of the small facilities is finished (Yes at step S26), it outputs a selection instruction to the selection unit 44.

When the selection unit 44 receives the selection instruction input from the determination unit 42, it decides the selection candidate based on the actual evaluated values with reference to the agent information storage unit 60 (step S29). The selection unit 44 outputs the decided selection candidate to the simulation result output unit 50.

The simulation management unit 30 moves the agent to the decided selection candidate (step S30). The simulation management unit 30 decides purchase in the small facility of the selection candidate and outputs the movement of the agent and a purchase result to the simulation result output unit 50 (step S31). The simulation apparatus 1 may thereby reproduce change in the searching action with an impressive event. For example, the simulation apparatus 1 may reproduce the purchase judgment action which is changed by the anchor event chance while maintaining the framework of reproduction of the action of searching for the facility having the highest evaluated value, which involves the comparison between all combinations.

Thus, the simulation apparatus 1 performs the checking action of checking, by the agent, the plurality of selection candidates in order for which the expected values are respectively set. The simulation apparatus 1 calculates the evaluated value of the selection candidate for the agent every time the agent checks the selection candidate. The simulation apparatus 1 performs continuation judgment of the checking action based on the expected values of the unchecked selection candidates and the evaluated value of the checked selection candidate every time the agent checks the selection candidate. The simulation apparatus 1 modifies the expected values of the unchecked selection candidates based on the evaluated value of the selection candidate after the agent finishes checking of at least any one of the plurality of selection candidates. As a result, the simulation apparatus 1 may reproduce the change in the searching action with the impressive event.

The simulation apparatus 1 modifies the expected values of the unchecked selection candidates based on the evaluated value of the selection candidate when the anchor event as the impressive event for the agent occurs. As a result, the simulation apparatus 1 may reproduce the change in the searching action with occurrence of the impressive event.

In the simulation apparatus 1, the anchor event is checking of the first selection candidate, the in-store campaign, the number of the checked selection candidates, the period of time during which the agent stays in the facility having the plurality of selection candidates, the walking-around distance of the agent, the passage of a predetermined period of time, or a combination thereof. As a result, the simulation apparatus 1 may modify the expected values of the unchecked selection candidates in accordance with various events.

The simulation apparatus 1 evaluates the ripple effect of the anchor event using a result of the continuation judgment of the checking action. As a result, the simulation apparatus 1 may evaluate influence on walking-around in the overall complex facility by the measure of holding the anchor event.

The simulation apparatus 1 modifies such that the average value of the distribution of the expected values of the unchecked selection candidates is equal to the evaluated value of the selection candidate. As a result, the simulation apparatus 1 may set the distribution of the expected values of the unchecked selection candidates to the vicinity of the evaluated value of the selection candidate.

The simulation apparatus 1 calculates the estimated best value based on the evaluated value of the selection candidate and modifies such that the average value of the distribution of the expected values of the unchecked selection candidates is equal to the calculated estimated best value. As a result, the simulation apparatus 1 may set the distribution of the expected values of the unchecked selection candidates to the vicinity of the estimated best value.

The simulation apparatus 1 modifies such that the median or the mode of the distribution of the expected values of the unchecked selection candidates is equal to the evaluated value of the selection candidate. As a result, the simulation apparatus 1 may appropriately set the expected values of the unchecked selection candidates even when the distribution of the expected values of the unchecked selection candidates deviates.

The simulation apparatus 1 calculates the estimated best value based on the evaluated value of the selection candidate and modifies such that the average value of the distribution of the expected values of the unchecked selection candidates is equal to the intermediate value between the evaluated value of the selection candidate and the calculated estimated best value. As a result, the simulation apparatus 1 may set the distribution of the expected values of the unchecked selection candidates based on the evaluated value of the selection candidate and the estimated best value.

The simulation apparatus 1 modifies such that a relatively large value is added to each of the expected values of the unchecked selection candidates as the evaluated value of the selection candidate is relatively higher than the distribution of the expected values of the unchecked selection candidates. The simulation apparatus 1 modifies such that a relatively large value is subtracted from each of the expected values of the unchecked selection candidates as the evaluated value of the selection candidate is relatively lower than the distribution of the expected values of the unchecked selection candidates. As a result, the simulation apparatus 1 may reproduce the change in the searching action with the impressive event.

The simulation apparatus 1 judges to finish the checking action when a maximum value of the evaluated values of the checked selection candidates is higher than a maximum value of the expected values of the unchecked selection candidates. The simulation apparatus 1 judges to continue the checking action when the maximum value of the evaluated values of the checked selection candidates is lower than the maximum value of the expected values of the unchecked selection candidates. As a result, the simulation apparatus 1 may reproduce the change in the searching action with the impressive event.

Each of the components of each of the units illustrated in the drawings are not necessarily configured physically as illustrated in the drawings. For example, specific forms of dispersion and integration of each of the units are not limited to those illustrated in the drawings, and all or a part of them may be configured to be dispersed or integrated functionally or physically based on a desired unit depending on various loads and usage conditions, or the like. For example, the determination unit 42 and the selection unit 44 may be integrated with each other. Various pieces of processing illustrated in the drawings are not limited to be executed in the above-described order and may be simultaneously executed or may be executed while switching the order in a consistent range of processing contents.

All or a desired part of various processing functions that are executed by the simulation apparatus 1 in the above-described embodiment may be implemented on a central processing unit (CPU) (or microcomputer such as micro processing unit (MPU) and micro controller unit (MCU)). It is needless to say that all or a desired part of the various processing functions may be implemented on a program to be analyzed and executed by the CPU (or microcomputer such as MPU and MCU) or may be implemented with hardware by wired logic.

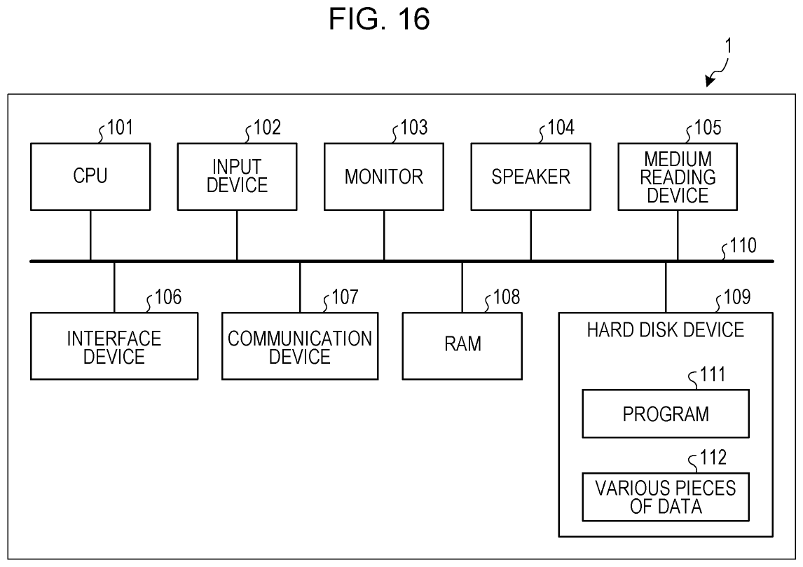

Various pieces of processing described in the above-described embodiment may be implemented by executing a previously prepared program by a computer. Hereinafter, an example of the computer (hardware) executing the program having the same functions as those in the above-described embodiment will be described. FIG. 16 is a block diagram illustrating an example of the hardware configuration of the simulation apparatus in the embodiment.

As illustrated in FIG. 16, the simulation apparatus 1 includes a CPU 101 executing various pieces of operation processing, an input device 102 receiving data input, a monitor 103, and a speaker 104. The simulation apparatus 1 further includes a medium reading device 105 reading a program or the like from a storage medium, an interface device 106 for connection with various devices, and a communication device 107 for wireless or wired communication connection with an external apparatus. The simulation apparatus 1 includes a RAM 108 temporarily storing various pieces of information and a hard disk device 109. Each of the units (101 to 109) in the simulation apparatus 1 are connected to a bus 110.

The hard disk device 109 stores therein a program 111 for executing the various pieces of processing described in the above-described embodiment. The hard disk device 109 stores therein various pieces of data 112 to which the program 111 refers. The input device 102 receives input of operation information from an operator of the simulation apparatus 1, for example. The monitor 103 displays, for example, various screens on which the operator operates. For example, a printing apparatus or the like is connected to the interface device 106. The communication device 107 is connected to a communication network such as a local area network (LAN) and transmits and receives various pieces of information to and from an external apparatus via the communication network.

The CPU 101 reads the program 111 stored in the hard disk device 109 and expands and executes it on the RAM 108 for various pieces of processing. The program 111 may not be stored in the hard disk device 109. The simulation apparatus 1 may read and execute the program 111 stored in a storage medium readable by the simulation apparatus 1, for example. The storage medium readable by the simulation apparatus 1 corresponds to, for example, a portable recording medium such as a CD-ROM, a DVD disk, a Universal Serial Bus (USB) memory, a semiconductor memory such as a flash memory, a hard disk drive, or the like. The program may be stored in a device connected to a public network, the Internet, a local area network (LAN), or the like, and the simulation apparatus 1 may read and execute the program therefrom.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a simulation process for performing checking action of checking, by an agent, a plurality of selection candidates in order for which expected values are set, the simulation process comprising:
upon checking each of the plurality of selection candidates, calculating an evaluated value of each selection candidate for the agent, and performing continuation judgment of determining whether the checking action is to be performed for a next one of the plurality of selection candidates, based on the expected values of unchecked selection candidates for which the checking action has not been performed yet and the evaluated values of checked selection candidates for which the checking action has been performed; and
upon completion of checking a first selection candidate of the plurality of selection candidates, modifying the expected values of the unchecked selection candidates, based on the evaluated value of the first selection candidate.

2. The non-transitory, computer-readable recording medium of claim 1, wherein the modifying includes, upon occurrence of an anchor event that is an impressive event for the agent, modifying the expected values of the unchecked selection candidates, based on the evaluated value of the first selection candidate.

3. The non-transitory, computer-readable recording medium of claim 2, wherein the anchor event is checking of a first one of the plurality of selection candidates, an in-store campaign, checking of a number of the checked selection candidates, checking of period of time during which the agent is allowed to stay in a facility having the plurality of selection candidates, checking of a walking-around distance of the agent, passage of a predetermined period of time, or a combination thereof.

4. The non-transitory, computer-readable recording medium of claim 2, the simulation process further including evaluating a ripple effect of the anchor event by using a result of the continuation judgment of the checking action.

5. The non-transitory, computer-readable recording medium of claim 1, wherein the modifying is performed such that an average value of distribution of the expected values of the unchecked selection candidates is equal to the evaluated value of the first selection candidate.

6. The non-transitory, computer-readable recording medium of claim 1, wherein:
the modifying includes calculating an estimated best value based on the evaluated value of the first selection candidate; and
the modifying is performed such that an average value of distribution of the expected values of the unchecked selection candidates is equal to the calculated estimated best value.

7. The non-transitory, computer-readable recording medium of claim 1, wherein the modifying is performed such that a median or a mode of distribution of the expected values of the unchecked selection candidates is equal to the evaluated value of the first selection candidate.

8. The non-transitory, computer-readable recording medium of claim 1, wherein:
the modifying includes calculating an estimated best value based on the evaluated value of the first selection candidate; and
the modifying is performed such that an average value of distribution of the expected values of the unchecked selection candidates is equal to an intermediate value between the evaluated value of the first selection candidate and the calculated estimated best value.

9. The non-transitory, computer-readable recording medium of claim 1, wherein the modifying is performed such that:
a relatively large value is added to each of the expected values of the unchecked selection candidates as the evaluated value of the first selection candidate is relatively higher than distribution of the expected values of the unchecked selection candidates; and
a relatively large value is subtracted from each of the expected values of the unchecked selection candidates as the evaluated value of the first selection candidate is relatively lower than the distribution of the expected values of the unchecked selection candidates.

10. The non-transitory, computer-readable recording medium of claim 1, wherein the performing the continuation judgment includes:
judging to finish the checking action when a maximum value of the evaluated values of the checked selection candidates is higher than a maximum value of the expected values of the unchecked selection candidates; and
judging to continue the checking action when the maximum value of the evaluated values of the checked selection candidates is lower than the maximum value of the expected values of the unchecked selection candidates.

11. A simulation method for performing checking action of checking, by an agent, a plurality of selection candidates in order for which expected values are set, the simulation method comprising:
upon checking each of the plurality of selection candidates, calculating an evaluated value of each selection candidate for the agent, and performing continuation judgment of determining whether the checking action is to be performed for a next one of the plurality of selection candidates, based on the expected values of unchecked selection candidates for which the checking action has not been performed yet and the evaluated values of checked selection candidates for which the checking action has been performed; and
upon completion of checking a first selection candidate of the plurality of selection candidates, modifying the expected values of the unchecked selection candidates, based on the evaluated value of the first selection candidate.

12. A simulation apparatus for performing checking action of checking, by an agent, a plurality of selection candidates in order for which expected values are set, the simulation apparatus comprising:
a memory; and
a processor coupled to the memory and configured to:
upon checking each of the plurality of selection candidates, calculate an evaluated value of each selection candidate for the agent, and perform continuation judgment of determining whether the checking action is to be performed for a next one of the plurality of selection candidates, based on the expected values of unchecked selection candidates for which the checking action has not been performed yet and the evaluated values of checked selection candidates for which the checking action has been performed, and
upon completion of checking a first selection candidate of the plurality of selection candidates, modify the expected values of the unchecked selection candidates, based on the evaluated value of the first selection candidate.
